(19) United States
(12) Patent Application Publication
(10) Pub. No.: US 2012/0300087 A1
(43) Pub. Date: Nov. 29, 2012

(54) System and method for receiving and publishing product interest

(76) Inventors: Jane E. Shore, Rancho Mirage, CA (US); Deena Suffin, Rancho Mirage, CA (US)

(21) Appl. No.: 13/506,907

(22) Filed: May 23, 2012

Related U.S. Application Data
(60) Provisional application No. 61/519,509, filed on May 24, 2011.

(51) Int. Cl. H04N 5/225; G06F 15/16

(52) U.S. Cl. 348/207.1; 709/206; 709/204; 348/207.2; 348/E05.024

(57) ABSTRACT

A system and method for receiving and publishing product interest data using social networking for marketing products to target audiences gathered at live events, theme parks, retail establishments where product sponsors provide kiosks for participants use.

### PRIOR APPLICATION

This application claims the benefit of filing date of U.S. Provisional Application Ser. No. 61/519,509 filed May 24, 2011.

### FIELD OF THE INVENTION

The present invention is directed to a system and method for receiving and publishing product interest data using social networking in an appealing way for marketing products to target audiences, and receiving feedback from potential target audiences.

### BACKGROUND OF THE INVENTION

Social networking online services are based on creating a network or interest among people with shared interest and activities, including both individual-centered and group-centered networks for sharing ideas, activities, events, interests and so forth. Widespread use of these services takes place through the internet and individual use of e-mail and instant messaging transmitted by smart phones and feature phones, for example.

Networking content encompasses all things of interest to participants including details about products they purchase and use, as well as cost and rating of such products by existing users.

There is a need to provide for gathering and dissemination of interest information through social networking, which information includes product and consumer data of interest to both vendors and purchasers in a contemporary manner.

### SUMMARY OF THE INVENTION

A preferred embodiment of the invention comprises a system and method for marketing products in places where interested consumers are gathering or may already be gathered to learn more about these products or related products. In one arrangement, kiosks for carrying out the system and method of the invention are located in permanent and temporary locations such as retail outlets, places of entertainment, or special events for the purpose of enabling attendees to find out more about products being marketed, and to post instant messages and photos to a social networking site such as Facebook.

In use, prospective consumers or participants register with the system in one of several ways. Participants may enter user data, such as a Facebook (or other social media platform's) user name, password, and/or e-mail address at a registration kiosk, or scan a Quick Response (QR) code on a kiosk sign to login using a smart phone. A legal statement can be provided to stipulate that users agree to participate and to give all photo rights to a product sponsor. The user data is then encrypted and written into a machine readable token, such as a RFID tag which can be a collectible item given to the participant having the information embedded within it. Alternatively, the system issues the participant a QR code which can be printed on a sticker and placed on a credential tag, or the system can send to the QR code to the user's smart phone. The RFID tags and QR codes generated by the system can be used by the user for instant posting and photo opportunities.

Instant posting kiosks are located throughout the event location associated with specific products. The kiosks provide touchscreens that show the message that will be posted to Facebook or other social media platform, or offer the ability to mark the item with a notation of interest, such as a “Like” for a product or to upload a specific post. A variety of product options are available and can be selected by participants to be posted to their News feed on Facebook. For example, the system can include programming to display to the participant on a kiosk video screen a plurality of predetermined messages and to permit the participant to choose one or more of the messages which the system can send to an internet website, such as a product sponsor's social media webpage. The sponsor can choose to have the predetermined message posted on the webpage. It can be appreciated that predetermined messages can be determined by a sponsor interested in receiving feedback about its product and can include statements, and variations thereof, such as “I like this product a lot,” “This is the best product among other similar products,” “This product is better than the last version,” “A certain aspect of this product is good,” “An aspect of this product could be improved,” and “An aspect of this product does not work,” among other things. Other options can be providing the participant to create their own comments.

Participants present their RFID wristband, or their smart phone, ticket or credential with QR code to the instant posting station and receive confirmation that their selection has been posted.

Photo opportunity kiosks are available to upload photos to a participant's Facebook or other social media platform's wall. Participants pose for a photo, swipe their RFID wristband, or QR code past the kiosk to have the photo uploaded. All photos can also be simultaneously posted to a site generated by the product sponsor. In addition, photos can be printed and given to participants with ability to have printed text and logos overlaid on top of the photos.

Specific examples are included in the following description for purposes of clarity, but various details can be changed within the scope of the present invention.

### OBJECTS OF THE INVENTION

An object of the invention is to provide a system and method for receiving and publishing product interest data using social networking.

Another object of the invention is to enable the use of social networking for marketing products.

Another object of the invention is to provide networking facilities at trade shows, retail establishments, and live events for marketing products.

Another object of the invention is to place networking kiosks for interested consumers to learn more about products, and for vendors to identify and reach their target market.

Another object of the invention is to distribute product information to participants at trade shows, retail establishments and live events, and by participants to their social network on Facebook.

Other and further objects of the invention will become apparent with an understanding of the following detailed description of the invention or upon employment of the invention in practice.

### BRIEF DESCRIPTION OF THE DRAWING

A preferred embodiment of the invention has been chosen for providing a detailed description to enable those having ordinary skill in the art to which the invention appertains to readily understand how to use the invention and is shown in the accompanying drawings in which:

FIG. 1 illustrates an embodiment of a system according to the invention.

FIG. 2 is an arrangement of a kiosk for registration of participants gathered in a place with products on display or sale.

FIG. 3 illustrates objects produced during registration including a credential tag, a smart phone, and a wrist band having encrypted information, such as name and password, which is embedded by a RFID tag or QR code, or sent to a smart phone and used after registration for instant posting and uploading photos to participant's social networking Facebook page.

FIG. 4 illustrates an embodiment of an instant posting kiosk according to the invention.

FIGS. 5a and 5b illustrate display information shown by an instant posting kiosk where a participant can indicate interest in a product, such as by using a “Like” function provided by a social media platform, such as their Facebook page.

FIGS. 6a and 6b illustrate additional display information shown by a posting kiosk highlighting product features and encouraging feedback on a social media platform, such as Facebook comments and discussion about the topic.

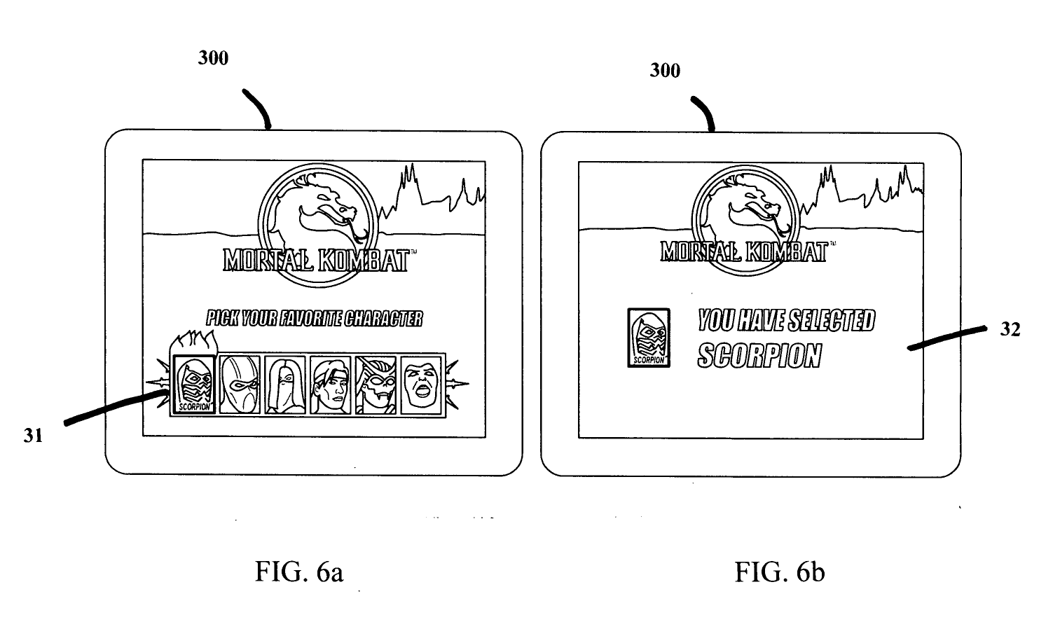

FIG. 7 is a schematic diagram detailing the system and method of the invention.

FIG. 8 illustrates a photo opportunity kiosk for uploading photos to a social media platform, such as a Facebook wall.

FIG. 9 shows steps performed by a system according to the invention.

FIG. 10 is a chart of information that is received by an embodiment of a system and method according to the invention.

FIG. 11 shows several messages which can be displayed on a screen of a kiosk according to the invention.

### DETAILED DESCRIPTION OF PREFERRED EMBODIMENT

Referring to the drawing, a preferred embodiment of the system and method of the invention is organized about kiosks placed where participants gather such as trade shows, theme parks, stores, live events and so forth.

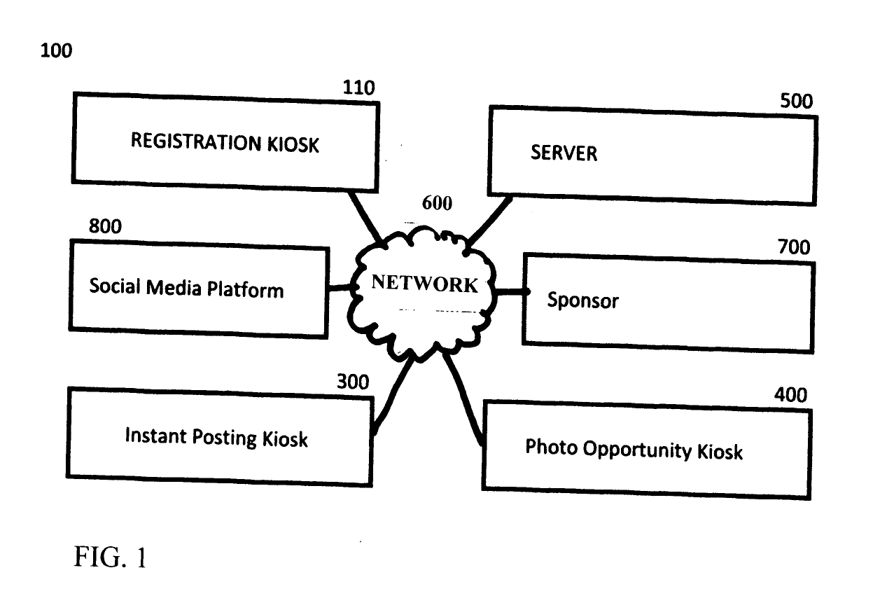

As shown in FIG. 1, a system 100 according to the invention includes one or more registration kiosks 110, instant posting Kiosks 300 and/or Photo Opportunity Kiosks 400 and one or more servers 500. The kiosks 110, 300, 400 are connected to servers 500 by communication connections, which can be hardwired or wireless. Kiosks 110, 300, 400 can be placed throughout an event venue for participant registration, instant postings of interest information by participants on social media platforms such as Facebook, and for providing participants with photo opportunities.

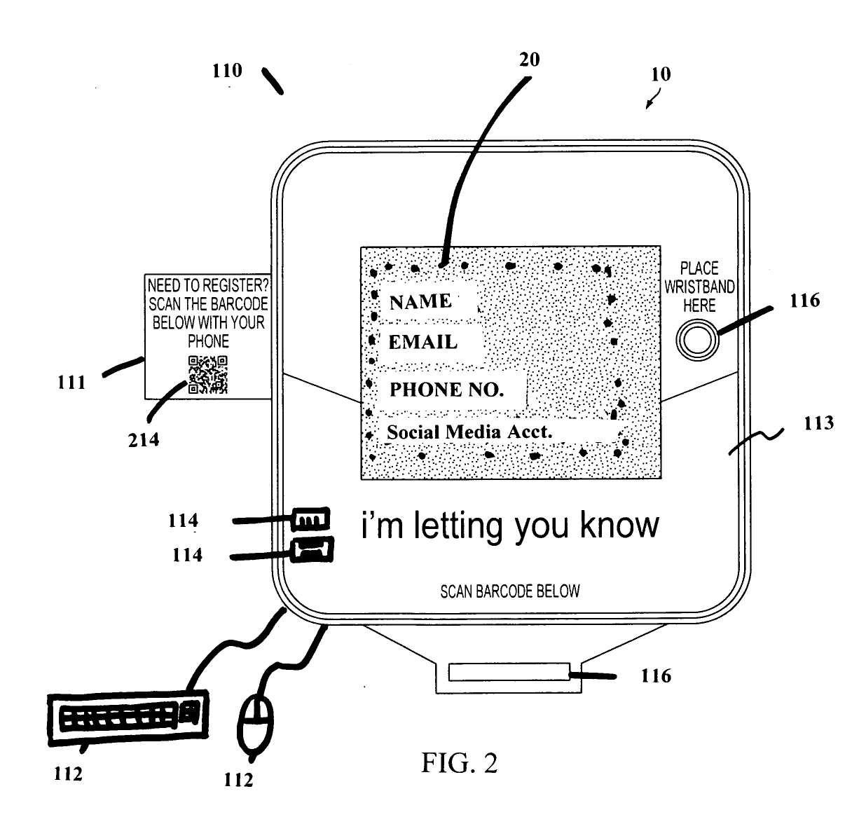

FIG. 2 shows an embodiment of a registration kiosk 110. During registration, the system can provide a registration Kiosk 110 programmed to request participants to provide user identification information 20 for use with a credential 17. User identification can include user name, password, email address, social media platform, user id, phone number, phone identification number, device identification information for a credential 17 such as a cell phone 213, among other things. Alternatively, the system can associate other device identification information for a credential 17 such as an RFID 220 or a credential tag on a pendant 211. The system 100 includes programming to permit participants when registering with the system 100 to use an event wristband, their smart phone or other credential for interacting with instant posting and photo opportunity kiosks.

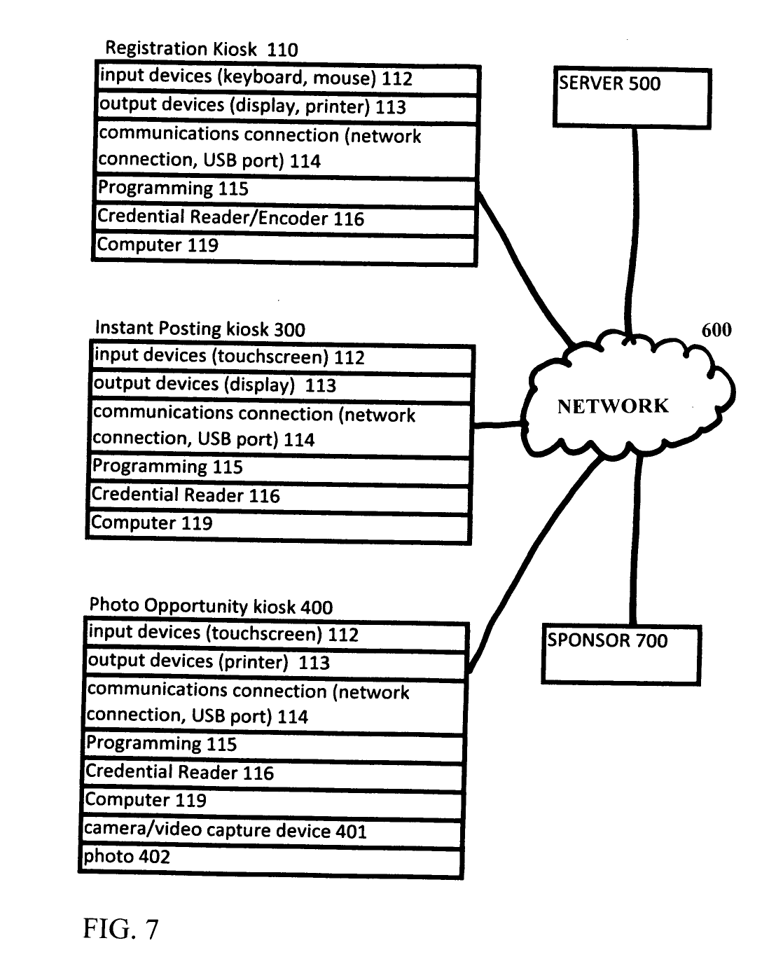

As shown in FIGS. 1, 2 and 7, a registration kiosk 100 includes a computer 119, programming 115 and a communication mechanism 114 such as Internet access and/or USB ports. The computer can be general purpose or specific for an application according to the invention. In addition, one or more user input devices 112 such as a keyboard or mouse is provided. Furthermore, a credential encoding system 116 such as RFID tag and/or QR Code reading/encoding systems is provided for encoding a credential 17 with information, including user information 20.

The kiosk 110 is also provided with one or more output devices 113, such as a display and/or printer. A kiosk 110 can be a stand-alone device or incorporated into one or more other kiosks or computer systems.

The kiosk 110 includes programming 115 to permit participants to register by entering their personal information 20 associated with one or more social media platforms 800, such as their Facebook page user name, password, and e-mail address associated with the participant.

In an alternative embodiment, a Quick Response (QR) Code is used to provide a link to an internet resident registration site provided on a server 500 whereby a user may scan the QR Code and be automatically directed to a website so that the participant may register using their smart phone. The system 100 can display a statement on the screen that the participant using the kiosk gives an associated product sponsor all photo rights of images taken by a photo opportunity kiosk 400. Thereafter a credential 17, such as a custom QR code for the registrant is generated by the system. In addition, a user name can be generated by the system or chosen by the participant and printed with the QR code for easy reading and identifying of the QR Code.

It can be appreciated that other Near Field Communication systems technology for communicating participant Identification information, such as through a smartphone, can be provided through programming at a kiosk for receiving such information as well as other functions such receiving participant identification authentication. In addition, the kiosk can include programming to receive account information associated with a participant, such as being sent by a participant's smartphone, as well as programming to receive approval information from the participant of a transaction. For example, a participant may desire to make payment from an account associated with the participant for purchase of a product displayed at a kiosk, and provide payment authorization by using the participant's smartphone.

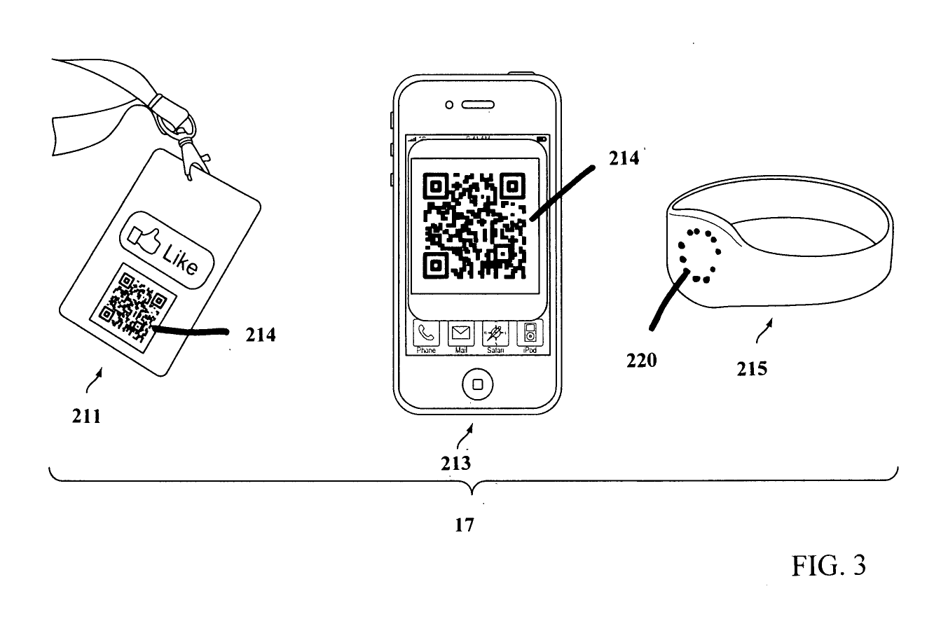

FIG. 3 illustrates several types of credential tags 17, such as a pendant 11 having a QR code sticker 214, a smart phone 213 which can receive and/or display a QR code 214, or a wristband 215 with embedded RFID tag 220. Credential tags 17 are created by the system 10 to enable a registrant to use one or more kiosks 110, 300, 400 such as by printing a readily usable identification device such as a QR Code sticker 214.

The system 100 includes programming 115 to securely encode the participant's user information and credentials 17, such as name and password, and embeds the information in a collectible item 17 such as a wristband given to the consumer. Additionally, the system 100 can provide participants with a QR code 214 which can be printed 24 on a adhesive label and placed on a credential such as a pendant 211, or sent 26 to their smart phone 213. The credential 17, such as the RFID tag and/or the QR code, can be used by the participant to access the instant posting and photo opportunities at system kiosks 110, 300, 400.

User information 20, such as user names and passwords are not stored on any of the kiosk computers 110, 300, 400 for security reasons. Instead, during registration, the system 100 uploads the user information 20 to a server 500 which the system 100 can query via programming 115 when a user presents their credential 17 at a kiosk 110, 300, 400. In addition, the use of credential tags 17 rather than the local storage of credential information at a kiosk can provide greater security and is beneficial to comply with typical rules of social media platforms, such as specific security and privacy rules associated with a social media platform. Registration kiosks 110 can also include information such as handouts explaining details of system security to participants.

In an alternative embodiment of the invention, registration kiosks 110 can also display product sponsor logos, and on-screen media can be included to provide sponsor's corporate identity and messages or news for the ongoing event.

The registration kiosk 110 can generate and embed a user ID number into a credential 17, such as the QR code or RFID tag. In addition, the kiosk 110 includes programming whereby if a credential 17 is lost, a participant can cancel the participant's existing identification number and request the issuance of a new one from the registration kiosk 110. The system is designed so that the information stored on any credential 17 is only able to identify that user though contact with the network server 500.

The network server 500 receives and stores participant information, such as E-mail addresses entered during registration at a registration kiosk 110 and can make the email addresses available to a product sponsor 700 by permitting the sponsor to download the information from the system 100 or by forwarding the information from the network server 500 to the product sponsor 700. The system 100 can further include programming 115 to permit the user to designate one or more fields of other user information that may not be made available to a product sponsor. The system 100 can provide additional user information 20, such as security preferences for the user to set during registration which can be used by the system 100 to limit the use of user information 20. Alternatively, the system can obtain such security preferences from the user's profile associated with a social media platform 800 which the user may designate. The user provides their email address as part of the registration process and this information can be given to the product sponsor 700 if requested by the sponsor 700 and/or permitted by the registrant.

As shown in FIGS. 1, 4 and 7, a system 100 according to the invention can include one or more instant posting kiosks 300 and/or photo opportunity kiosks 400 which can be positioned throughout an event location. Each kiosk 300, 400 can be associated with one or more specific products, or product sponsors. Each kiosk includes one or more input mechanisms 112 and output mechanisms 113 such as a touchscreen, a computer 119, a communication mechanism 114, such as a network connection, and a RFID tag reader or QR code reader 116. In addition a graphic on the kiosk surface can be provided to indicate a place for a participant to utilize the credential tag 17, such as by swiping a wristband or QR code.

In another embodiment of the invention, participants may also scan a bar code 214 from another form of credential 17 such as a ticket, or pendant 211. The kiosk 110 can be provided with an input such as a barcode reader 116 for scanning the bar code 214, whereupon by scanning the credential, the kiosk receives user information which can then be authenticated by the network server 500.

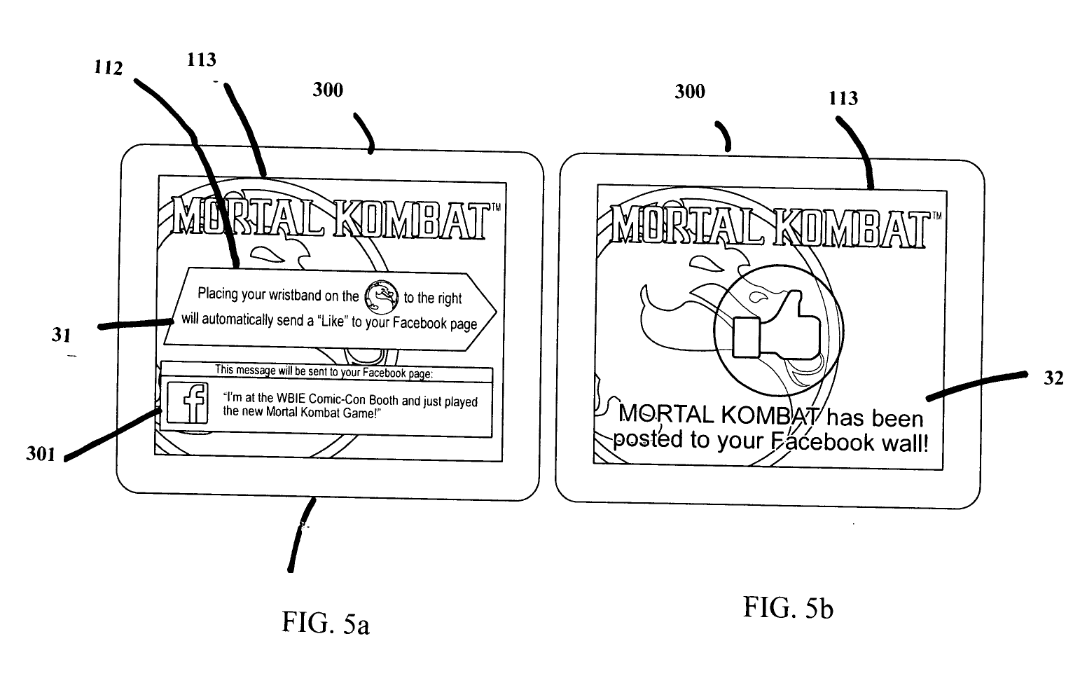

Each kiosk is provided with a kiosk screen 113 for displaying information to a user. Information related to the product and or sponsor is displayed on one or more screens of the kiosk. For example, photos, video and/or textual and other graphical information can be provided in association with the product or product sponsor. As shown in FIGS. 5a and 5b, the instant posting kiosks 300 can include programming 115 to display one or more predetermined messages. In one embodiment, a predetermined message 301 can be a message associated with a product which is received by the kiosk 300 from a sponsor 700 and saved in memory at the kiosk 300. The instant posting kiosk includes programming to post the message 301 to a social media platform 800 such as Facebook.

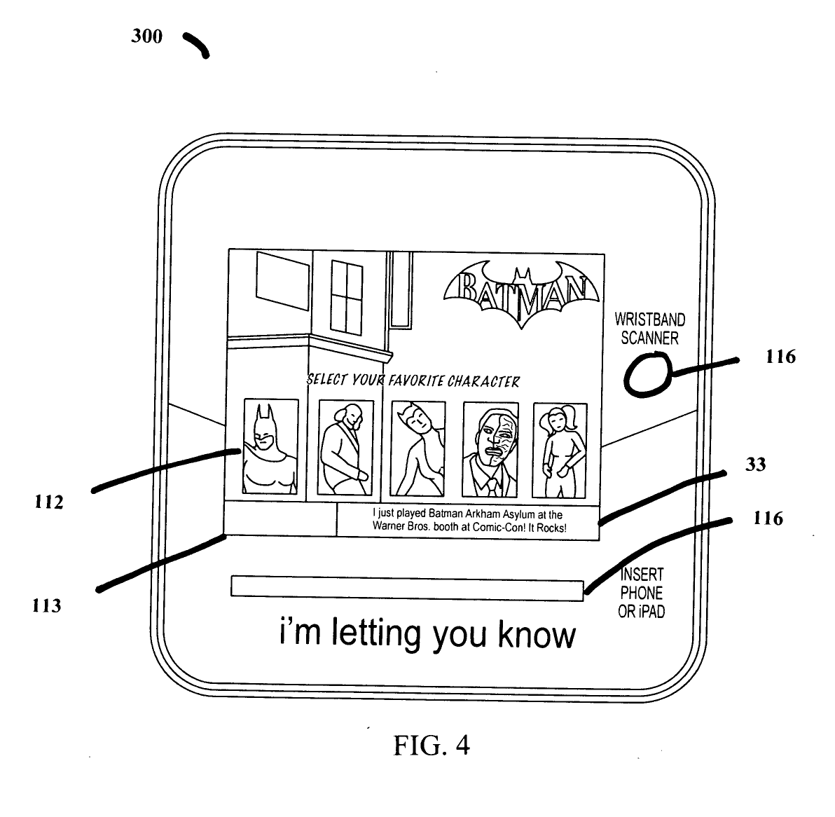

As shown in FIGS. 4a, 4b, 5a and 5b, in an alternative embodiment, one or more of the kiosks 100, 300, 400 can also include programming to offer the user the ability to demonstrate interest 31 in a product, an aspect of a product or to upload a specific post 33. For example, a variety of product options can be made available by the system (e.g. “Who is your favorite Batman character? Or “What is your favorite Mazda car model”) and can be selected by participants to be posted to the social media platform 700 such a news feed 35 of the platform.

Participants present their RFID tag or QR code by wristband, phone, ticket or credential to the instant posting station and the system can provide the participants with confirmation that their selection has been posted. In addition, the system 100 can include programming 115 to display an acknowledgement 32 that the interest 31 has been posted. An instant posting kiosk 300 may be freestanding or incorporated into a dedicated exhibit or placed by a product sponsor's booth at an event.

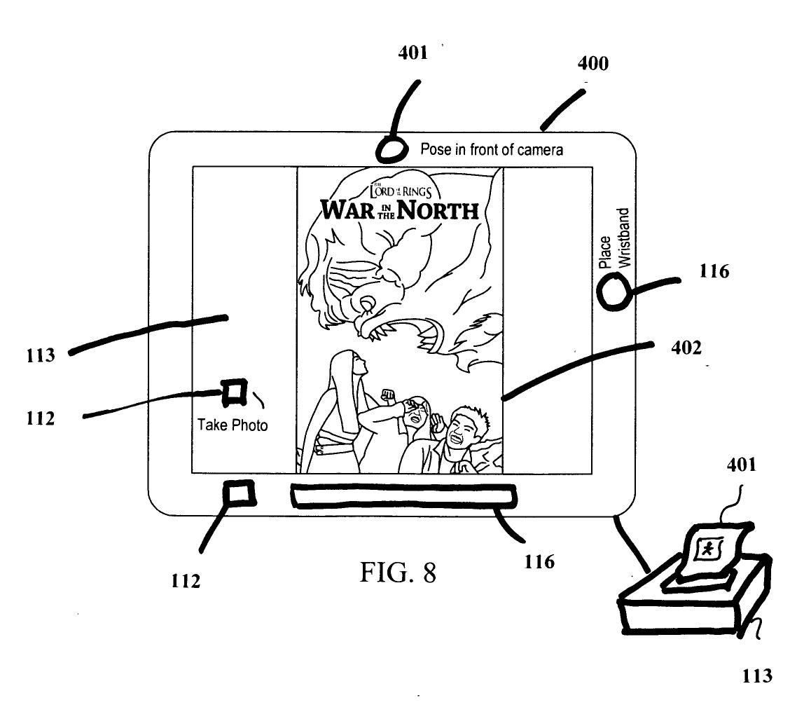

As shown in FIGS. 1, 7 and 8, a system 100 according to the invention can also include one or more photo opportunity kiosks 400. The kiosk 400 includes a computer 119, programming 115, a communications mechanism 114, and one or more input and output devices 112, 113, such as a touchscreen. Included, is programming 115 to enable a user to upload one or more photos taken by the kiosk 400 to a participant's Facebook wall or other social media platform 700. The system 100 can include a camera and/or video capture screen 401 to permit a participant to pose for a photo and have the photo uploaded to a webpage of a social media platform 800 associated with the participant or product. The photo and/or video can be displayed on the display, or touchscreen 113. In addition, the photo opportunity 400 kiosk includes an ID reader 116 so the user can swipe their RFID tag or QR code at the kiosk and their identity determined by the kiosk 400 by requesting an authentication from the server. The photo is then transmitted by the kiosk 400 to a server 500 which in turn submits the photo to the user's social media platform 800 specified by the user during registration and stored in the user information 200. The system can also provide that photos 402 submitted by a participant can also be sent to a product sponsor 700 via the server 500 to be simultaneously posted to a site generated by the product sponsor, thereby allowing for additional promotional value. In addition, the system 100 can include a printer 113 and programming 115 to permit a user to choose to print 48 one or more photos 402 at the kiosk 400. Furthermore, a system according to the invention can include programming 115 to permit participants to choose text and logos, which can be displayed on the screen 113 of the kiosk 400. The text and logos designated by the user can show on one or more of the photos and the system can send the photos with the text and/or logos to the printer 113 or to a product sponsor 700 or media platform 800 via the server 500.

Interactions with a kiosk 110, 300, 400 by a participant are recorded by the system 100 which can be stored by the computer at one or more of the kiosks 110, 300, 400 or at a server 500. The system 100 can include programming 115 to record the number of participants and their posting activity from each kiosk and to provide this information to the product sponsor 700 to track the registrants' activities, such as each interaction of the participant with a kiosk, such as their postings, identification of interest and choice of options presented by a kiosk, among other things.

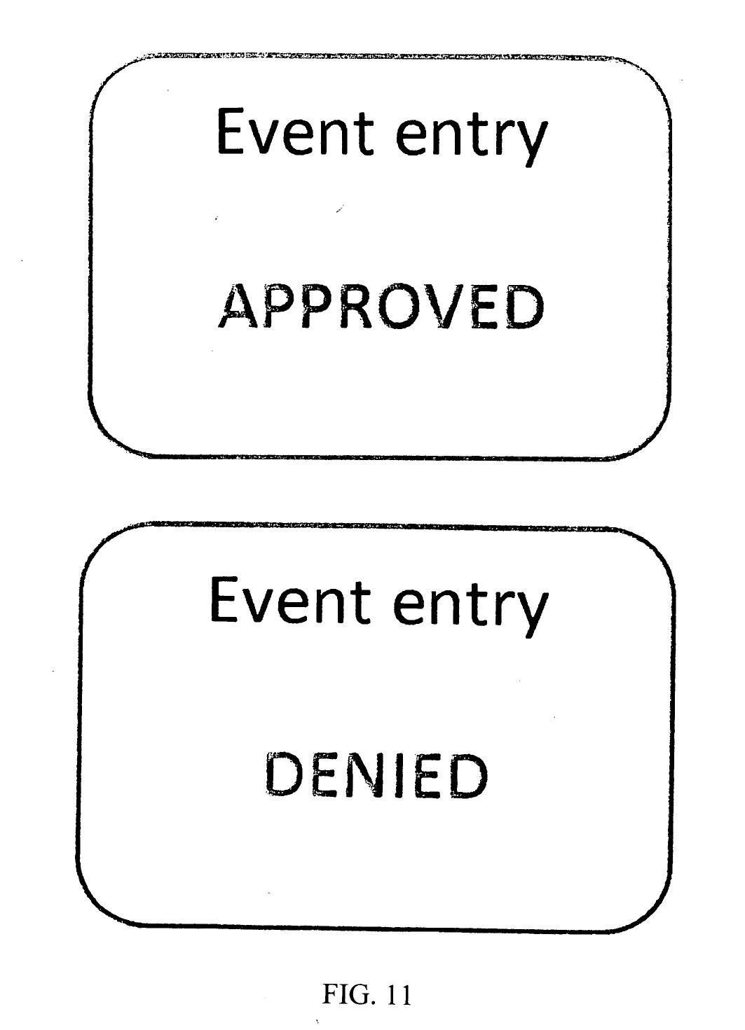

In a further embodiment of the invention, the system 100 can include programming 115 to provide for different levels of user access. For example, at invitation only-events, the system can be provided with programming 115 which differentiates between different participants, such as consumer and VIP guests, whereby the system provides different participant level information at kiosks 110, 30, 40 such as a visual signal including access level. Differing participant level information can be received by the system 100 from the participants during registration or can be provided by a manager or other use of the system. As another example, one or more kiosks 110, 300, 400 can be provided with on screen graphics which change indicating that the user is either approved or denied use of the kiosk depending on whether the user's level is at least equivalent to the level of access provided at the kiosk, such as shown in two exemplary screen in FIG. 11.

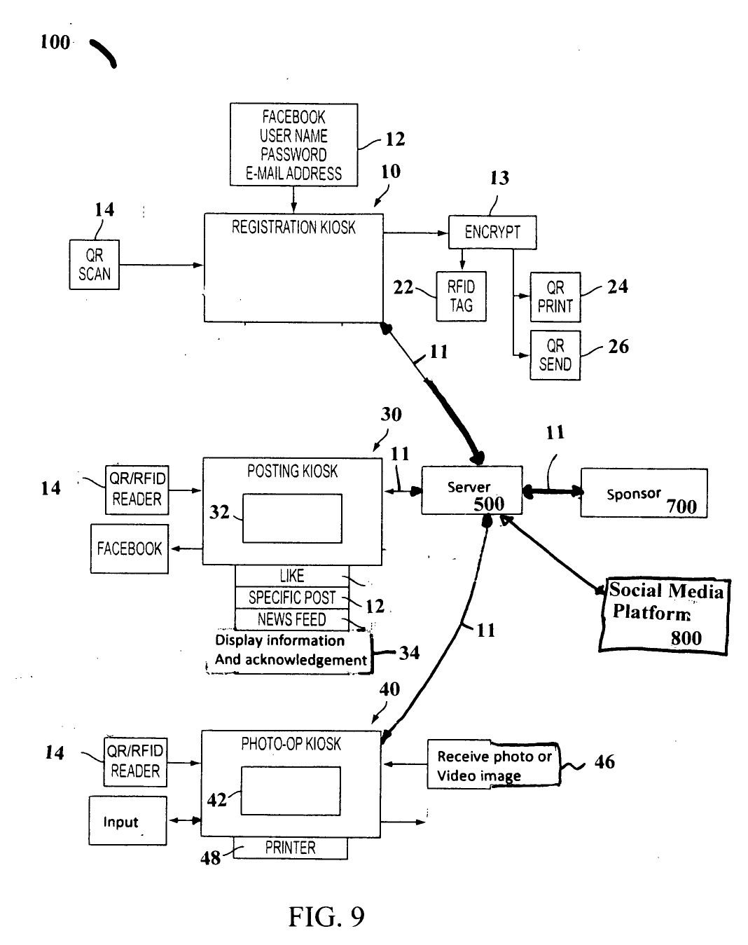

FIG. 9 illustrates schematically an embodiment of a system and method of the invention 100. A registration kiosk 10 according to the invention receives 12 participant information including user name, password for each social media site that they wish to include, and e-mail address. The information 20 is transmitted 11 to a server 500 and can be associated with a social media platform such as Facebook. The user information 20 can be entered through a keyboard 12; or scanned and received 14 through another machine readable device such as a QR code scan of a credential or of a smart phone by a QR reader. Received information is encrypted 13 by the system 22 and is written onto a wristband having an embedded RFID tag 22, or printed 24 as a QR sticker which can be placed by a participant on a credential such as a pendant, or transmitted 26 to the participant's smart phone. Registration data is stored by the system 10 at a server 500 which can be transmitted 11 to the sponsor or marketer 700 sponsoring the products presented by a kiosk of the system 100.

Instant posting kiosks 300 according to the invention likewise scan and receive 14 user information. In addition, the initial posting kiosks 300 receive 12 information from participants, such as internet 31, post 33 and news feed 35 information—the kiosks 30 can be provided with touchscreens for receiving 12 the information as well as dispensing 32 information, such as information associated with specific products as well as displaying 34 acknowledgements. For example, a Mortal combat themed kiosk can be placed among Mortal Kombat video game stations and marketing materials. By using a RFID reader or a QR reader mounted on the kiosk, participants can post 12 a product message on the touchscreen to a social media platform, such as Facebook, and designate interest 12 in a product, such as by using a “Like” function or other interest indicator 12 and/or by uploading a specific post 12, and/or add to a news feed 12. A product message is a specific post 33 which can include information conveyed by the participant about the product or an aspect of the product, such as may be specified by the kiosk and prompted on kiosk screen by programming provided by the system Instant posting data can be transmitted 11 by the system to a marketer 700 via a server 500.

Photo opportunity kiosks 400 according to the invention receive 46 video information via a camera device. In addition, the kiosks 400 can include printing devices for printing 48 photos. A photo opportunity kiosk 400 also includes programming to receive 12 requests from participants to pose for a photo, print text and logos on top of the photo and to upload the photos, text, and/or logos to a social media platform, such as their Facebook wall. Photo opportunity data and photos can be transmitted 11 to the server 500 for storage and/or transmitted 11 to one or more marketers 700:

A system 100 according to the invention communicates with a network to transmit data it receives to social media platforms such as participant's Facebook pages and walls by instant posting. Photo opportunity kiosks can also provide access to dedicated pages associated with one or more kiosks on a social networking domain or other internet site which can be viewed and used by all who have access to the dedicated page. For example, a product sponsor may have an account and associated webpage on a social media website for the product sponsor itself, or for one or more products.

In another embodiment of the invention, one or more kiosks 110, 300, 400 can also be provided with programming whereby the kiosk presents a participant with an opportunity to enter a contest. For example, the system 100 can include programming to display information on a kiosk display indicating an option for a participant to enter a contest, and a button or other another manner by which a participant can accept or deny the invitation to enter the contest. In addition, or in the alternative, the system 100 can include programming whereby the participant can present their QR or RFID identification 17 for indicating their interest in accepting the invitation to enter the contest, whereafter the system collects the participants identification information from the QR or RFID identification 17 and transmits that information to the server 500 for entering the participant into the contest. The system 100 can include programming associated with the server 500 for maintaining a database of all participants who have accepted the invitation to enter the contest. In addition, or in the alternative, the system 100 can include programming whereby the system 100 informs a sponsor 700 of the participants who have entered the contest, and/or update a website such as a social media pages associated with the sponsor for updating information regarding the contest, such as number of participant entries. The sponsor 700 may then choose a winner from among the entries.

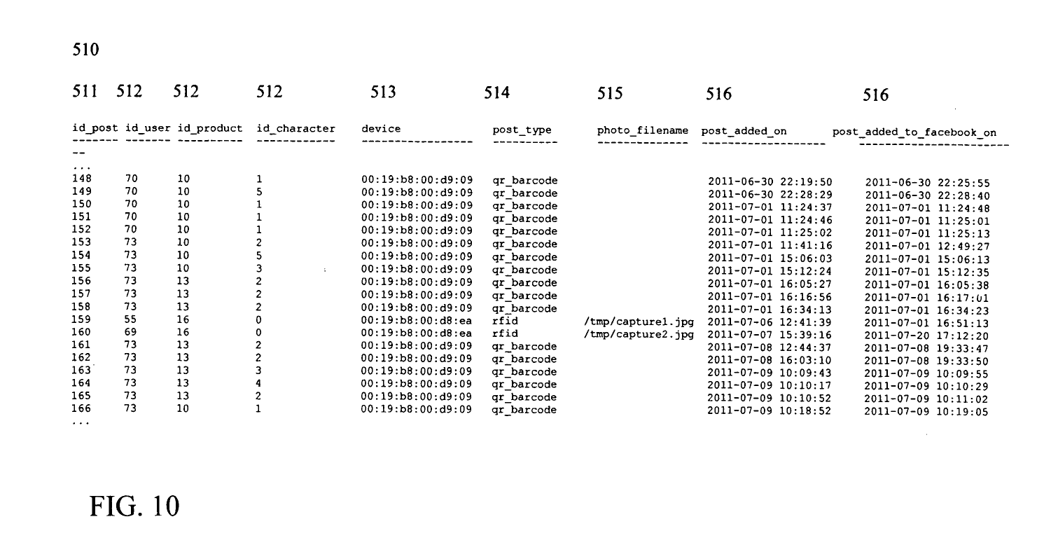

FIG. 10 shows an example of a database 510 containing data, associated with a posts table including interest information and code for product sponsors. In one embodiment, each time interest information is recorded, the event is associated with a post. For example, an “id_post” 511 field can be provided for storing information associated with a unique identifier for each post. In this embodiment, the id_post field information also represents the number of the post. In addition, an “id_user,” “id_product,” and “id_character” fields 512 can also be provided for storage of information identifying the participant, client, and product associated with an interest information event. Furthermore, a “device” field 513 can be provided to identify the client machine, such as a kiosk, and a “post_type” field 514 can be provided to identify the a triggering token, RFID tag or other device having embedded user information. A “photo_filename” field 515 can be provided to store information identifying a file associated with the interest information event which can be stored on the server or other location that holds an image uploaded or posted by a user. Furthermore, a “post_added_on” and a “post_added_to_facebook_on” field 516 can also be provided to store information associated with an interest event indicating the date and/or time of the event or when the post was requested at the kiosk and/or the date/time the post was accepted by Facebook or other social media site.

Various changes may be made to the structure embodying the principles of the invention. The foregoing embodiments are set forth in an illustrative and not in a limiting sense. The scope of the invention is defined by the claims appended hereto.

I claim:

1. A system for receiving and publishing product interest data for use with a social network comprising:
a network server for receiving, transmitting and storing information, said network server being communicatively connected to a social media network website and an instant posting kiosk,
said social media network website including programming to receive posted information, and to publish the posted information on a website, wherein the posted information is selected from the group comprising interest information, textual information and image information,
said instant posting kiosk being in communication with the network server, the instant posting kiosk having a screen, at least one input device for receiving information from a participant, and programming to display information on the screen, to receive information from the input device and to send and receive information to and from the network server,
wherein the instant posting kiosk further comprises programming for displaying a predetermined message regarding a product, programming to prompt a response from a participant regarding the predetermined messages, programming to receive the response from the participant and programming to transmit the response to the network server for posting on the social media network website.

2. A system according to claim 1, wherein the programming further enables participants to express interest in a post, and including programming to post product data selected by a participant to a News Feed of the social network.

3. A system according to claim 1, further comprising programming to prompt a response from a participant regarding the predetermined messages includes programming to prompt a product interest response from a participant, programming to prompt a participant to choose from a plurality of product interest responses, and programming to permit a participant programming to create their own response.

4. A system according to claim 1, wherein the input device includes an automatic connection device and associated programming for receiving identification information from an identification tag, and automatically connecting to a social media website associated with the identification.

5. A system according to claim 1, wherein the identification tag is chosen from the group comprising an RFID tag and a QR code, and wherein the screen is a touchscreen.

6. A system according to claim 1, further comprising programming to prompt a response from a participant to enter a contest, programming to receive a contest response from a participant, programming to associate participant identification information of the participant with the contest response, and programming to transmit the contest response and participant identification information to the network server.

7. A system according to claim 1, further comprising a photo opportunity kiosk in communication with the system computer, the photo opportunity kiosk having a camera for taking photos, and a printer for printing photos.

8. A system according to claim 7, wherein the photo opportunity kiosk further comprises an input device including an automatic connection device and associated programming for receiving identification information from an identification tag, and automatically connecting to a social media website associated with the identification, and programming for uploading photos to a social media website.

9. A system according to claim 7, wherein the photo opportunity kiosk further includes programming for posting all photos to a website site associated with a product sponsor.

10. A system according to claim 1, further comprising registration kiosk for receiving social networking user data including name, password, and e-mail addresses of participants, the registration kiosk including a system computer in communication with a network, a keyboard, and an encrypting system for encrypting RFID and QR codes; and an embedding device for embedding RFID codes in RFID tags.

11. A system according to claim 10, further comprising a printing device for printing QR codes.

12. A system according to claim 10, further comprising communication device for sending QR codes to smartphones.

13. A Method for Receiving and Publishing Product Interest, comprising the steps of:
receiving identification information and associated social network information from a participant,
presenting product information,
requesting product feedback,
receiving product feedback at a kiosk, and
publishing the product feedback on a social network website.

14. The method of claim 13 further comprising the step of receiving associated social network information from a participant and authenticating the associated social network information with a social network.

15. The method of claim 14 wherein the step of publishing the product feedback on a social network website includes publishing the product feedback on a social network website associated with the participant.

16. The method of claim 14 wherein the step of publishing the product feedback on a social network website includes publishing the product feedback on a social network website associated with a product sponsor.

17. The method of claim 13 wherein the feedback is selected from the group comprising an identification of interest, a comment, a photo, and a selected response from a plurality of choices presented to the participant.

18. The method of claim 13 wherein the step of publishing the product feedback on a social network website includes publishing the product feedback with a specific posted message associated with a product on a social network website.

19. The method of claim 13 wherein the step of receiving identification information from a participant includes receiving participant identification information from a credential associated with the participant, wherein the credential is selected from the group comprising a device having an RFID and a device having a QR code.

20. The method of claim 13 further comprising presenting contest information at a kiosk, receiving a contest response from a participant, associating participant information with the contest response, transmitting the participant information with the contest response to a network server, selecting a winner identification from a plurality of participants including the participant, and publishing the winner identification on a social network website.
